(19) United States
(12) Patent Application Publication
(10) Pub. No.: US 2015/0081360 A1
(43) Pub. Date: Mar. 19, 2015

(54) Order/Vehicle Assignment Based on Order Density

(71) Applicants: Godfrey Sun, Shanghai (CN); Heng Wang, Shanghai (CN); Yu Cheng, Shanghai (CN); Wen-Syan Li, Fremont, CA (US)

(72) Inventors: Godfrey Sun, Shanghai (CN); Heng Wang, Shanghai (CN); Yu Cheng, Shanghai (CN); Wen-Syan Li, Fremont, CA (US)

(73) Assignee: SAP AG, Walldorf (DE)

(21) Appl. No.: 14/066,015

(22) Filed: Oct. 29, 2013

(30) Foreign Application Priority Data
Sep. 18, 2013 (CN) 201310426553.9

(51) Int. Cl. G06Q 50/28; G06Q 10/06

(52) U.S. Cl. CPC G06Q 50/28; G06Q 10/06311
USPC 705/7.13

(57) ABSTRACT

Example systems and methods of assigning shipping orders to delivery vehicles are presented. In one example, a delivery region may be segmented into delivery blocks. A shipping order density may be determined for each of the delivery blocks. Adjacent delivery blocks having corresponding shipping order densities may be merged to yield delivery areas. A cost of using each type of available delivery vehicle to transport a delivery job may be determined relative to a cargo capacity of the vehicle type, a delivery distance, and a shipping order density. Each of the delivery areas may be partitioned into delivery jobs based on the cost of using each of the vehicle types. Each of the delivery jobs may be assigned to one of the available delivery vehicles based on minimizing a total cost of using the vehicles to transport the delivery jobs.

### CLAIM OF PRIORITY

The present patent application claims the priority benefit of the filing date of Chinese Application (SIPO) No. 201310426553.9 filed Sep. 18, 2013, the entire content of which is incorporated herein by reference.

### FIELD

This application relates generally to data processing and, in an example embodiment, to assignment of shipping orders to delivery vehicles.

### BACKGROUND

Many organizations tasked with the delivery of goods over a particular distribution area maintain a vested interest in determining the most economical way to deliver or transport those goods using the delivery vehicles available to the organization. More specifically, the organization may want to use the overall least expensive means to deliver the goods to their intended destinations to lower the overall operating costs associated with fulfillment of shipping orders for those goods.

However, determining a delivery solution for a particular set of shipping orders to a diverse set of destinations historically has been a rather complex task, often demanding many calculations and trials to arrive at a solution that is at least somewhat optimally efficient. In many cases, arriving at such a solution is complicated by the total number of transport destinations possibly being large and being located disproportionally about a delivery depot. Also, the types and sizes of shipping orders may vary greatly, further obscuring the process.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an example system having a client-server architecture for an enterprise application platform capable of employing the systems and methods described herein;

FIG. 2 is a block diagram of example applications and modules employable in the enterprise application platform of FIG. 1;

FIG. 3 is a block diagram of an example application employable to assign shipping orders to delivery vehicles;

FIGS. 4A through 4F are descriptions of example database table formats employable for assigning shipping orders to delivery vehicles;

FIG. 5 is a flow diagram illustrating an example method of assigning shipping orders to delivery vehicles;

FIG. 6 is a graphical representation of an example delivery region including delivery blocks and associated delivery areas;

FIG. 7 is a flow diagram illustrating an example method of assigning delivery blocks to delivery areas based on shipping order densities; and

FIG. 8 is a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that exemplify illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

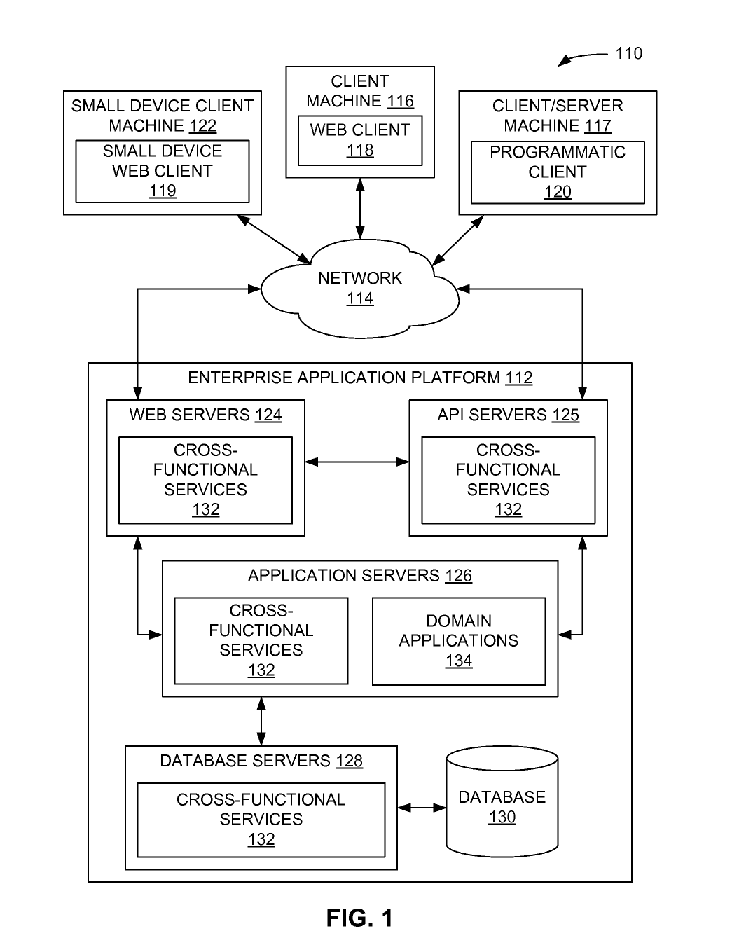

FIG. 1 is a network diagram depicting an example system 110, according to one exemplary embodiment, having a client-server architecture configured to perform the various methods described herein. A platform (e.g., machines and software), in the exemplary form of an enterprise application platform 112, provides server-side functionality via a network 114 (e.g., the Internet) to one or more clients. FIG. 1 illustrates, for example, a client machine 116 with a web client 118 (e.g., a browser, such as the Internet Explorer® browser developed by Microsoft® Corporation), a small device client machine 122 with a small device web client 119 (e.g., a browser without a script engine), and a client/server machine 117 with a programmatic client 120.

Turning specifically to the enterprise application platform 112, web servers 124 and application program interface (API) servers 125 are coupled to, and provide web and programmatic interfaces to, application servers 126. The application servers 126 are, in turn, shown to be coupled to one or more database servers 128, which may facilitate access to one or more databases 130. The web servers 124, API servers 125, application servers 126, and database servers 128 may host cross-functional services 132. The application servers 126 may further host domain applications 134.

The cross-functional services 132 may provide user services and processes that utilize the enterprise application platform 112. For example, the cross-functional services 132 may provide portal services (e.g., web services), database services, and connectivity to the domain applications 134 for users that operate the client machine 116, the client/server machine 117, and the small device client machine 122. In addition, the cross-functional services 132 may provide an environment for delivering enhancements to existing applications and for integrating third-party and legacy applications with existing cross-functional services 132 and domain applications 134. Further, while the system 110 shown in FIG. 1 employs a client-server architecture, the present disclosure is, of course, not limited to such an architecture, and could equally well find application in a distributed or peer-to-peer architecture system.

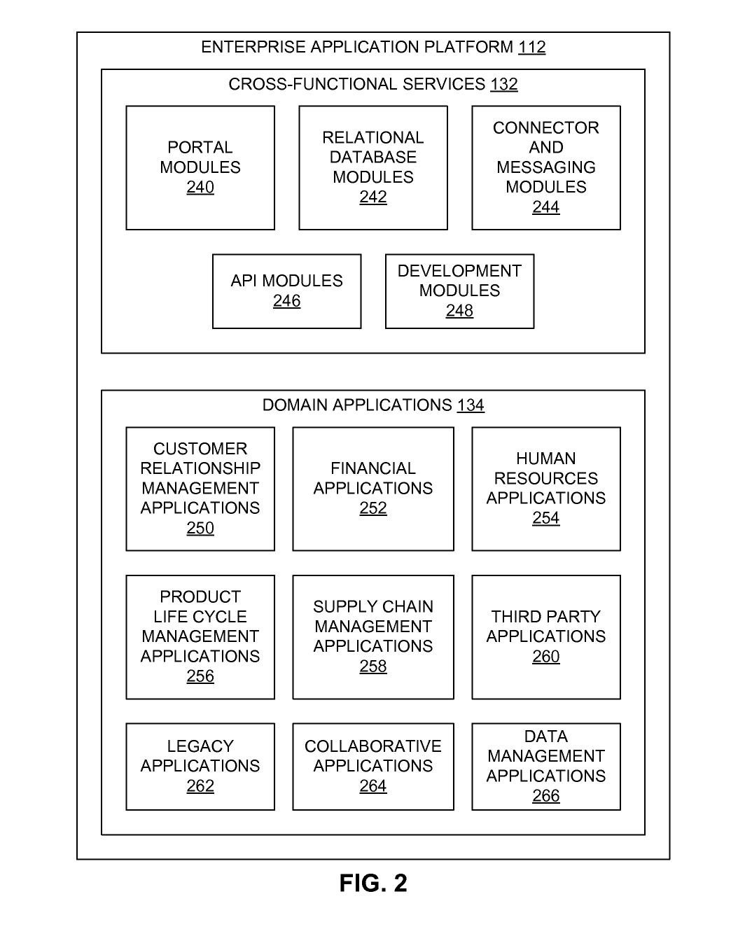

FIG. 2 is a block diagram illustrating example enterprise applications and services, such as those described herein, as embodied in the enterprise application platform 112, according to an exemplary embodiment. The enterprise application platform 112 includes cross-functional services 132 and domain applications 134. The cross-functional services 132 include portal modules 240, relational database modules 242, connector and messaging modules 244, API modules 246, and development modules 248.

The portal modules 240 may enable a single point of access to other cross-functional services 132 and domain applications 134 for the client machine 116, the small device client machine 122, and the client/server machine 117 of FIG. 1. The portal modules 240 may be utilized to process, author, and maintain web pages that present content (e.g., user interface elements and navigational controls) to the user. In addition, the portal modules 240 may enable user roles, a construct that associates a role with a specialized environment that is utilized by a user to execute tasks, utilize services, and exchange information with other users and within a defined scope. For example, the role may determine the content that is available to the user and the activities that the user may perform. The portal modules 240 may include, in one implementation, a generation module, a communication module, a receiving module, and a regeneration module. In addition, the portal modules 240 may comply with web services standards and/or utilize a variety of Internet technologies, including, but not limited to, Java®, Java 2 Platform—Enterprise Edition (J2EE), SAP's Advanced Business Application Programming (ABAP®) Language and Web Dynpro, eXtensible Markup Language (XML), Java Connector Architecture (JCA), Java Authentication and Authorization Service (JAAS), X.509, Lightweight Directory Access Protocol (LDAP), Web Services Description Language (WSDL), WebSphere Service Registry and Repository (WSRR), Simple Object Access Protocol (SOAP), Universal Description, Discovery and Integration (UDDI), and Microsoft.NET.

The relational database modules 242 may provide support services that include a user interface library for access to the database 130 (FIG. 1). The relational database modules 242 may provide support for object relational mapping, database independence, and distributed computing. The relational database modules 242 may be utilized to add, delete, update, and manage database elements. In addition, the relational database modules 242 may comply with database standards and/or utilize a variety of database technologies including, but not limited to, Structured Query Language (SQL), SQL Database Connectivity (SQLDBC), Oracle®, MySQL, Unicode, Java Database Connectivity (JDBC), as well as logging of database operations performed by the user, enforcing of database user access permissions, and the like.

The connector and messaging modules 244 may enable communication across different types of messaging systems that are utilized by the cross-functional services 132 and the domain applications 134 by providing a common messaging application processing interface. The connector and messaging modules 244 may enable asynchronous communication on the enterprise application platform 112.

The API modules 246 may enable the development of service-based applications by exposing an interface to existing and new applications as services. Repositories may be included in the platform 112 as a central place to find available services when building applications.

The development modules 248 may provide a development environment for the adding, integrating, updating, and extending of software components on the enterprise application platform 112 without impacting existing cross-functional services 132 and domain applications 134.

Turning to the domain applications 134, customer relationship management applications 250 may enable access to, and facilitate collecting and storing of, relevant personalized information from multiple data sources and business processes. Enterprise personnel who are tasked with developing a buyer into a long-term customer may utilize the customer relationship management applications 250 to provide assistance to the buyer throughout a customer engagement cycle.

Enterprise personnel may utilize financial applications 252 and business processes to track and control financial transactions within the enterprise application platform 112. The financial applications 252 may facilitate the execution of operational, analytical, and collaborative tasks that are associated with financial management. Specifically, the financial applications 252 may enable the performance of tasks related to financial accountability, planning, forecasting, and managing the cost of finance.

Human resources applications 254 may be utilized by enterprise personnel and business processes to manage, deploy, and track enterprise personnel. Specifically, the human resources applications 254 may enable the analysis of human resource issues and facilitate human resource decisions based on real-time information.

Product life cycle management applications 256 may enable the management of a product throughout the lifecycle of the product. For example, the product life cycle management applications 256 may enable collaborative engineering, custom product development, project management, asset management, and quality management among business partners.

Supply chain management applications 258 may enable monitoring of performances that are observed in supply chains. The supply chain management applications 258 may facilitate adherence to production plans and on-time delivery of products and services.

Third-party applications 260, as well as legacy applications 262, may be integrated with domain applications 134 and utilize cross-functional services 132 on the enterprise application platform 112.

Additionally, collaborative applications 264 may facilitate joint creation and modification of documents and other work product by multiple users, and data management applications 266 may enable data organization and other management functions to be performed on data generated by one or more other domain applications 134.

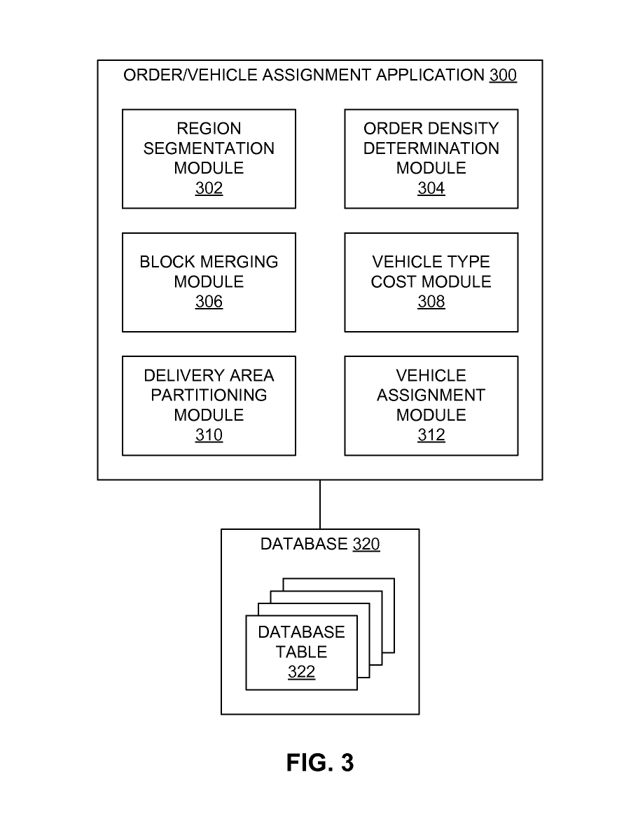

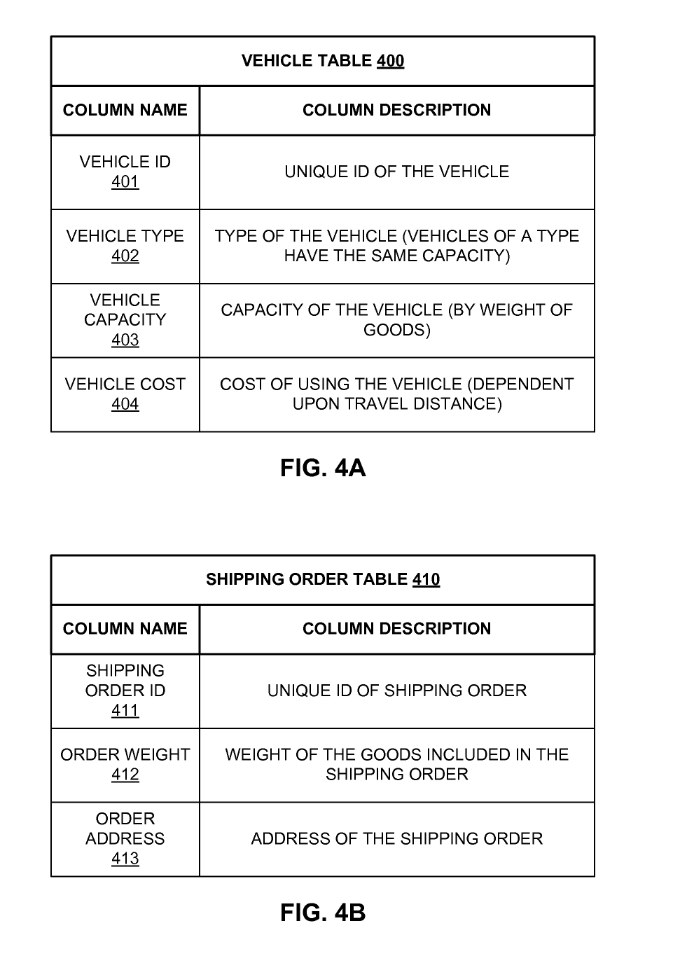

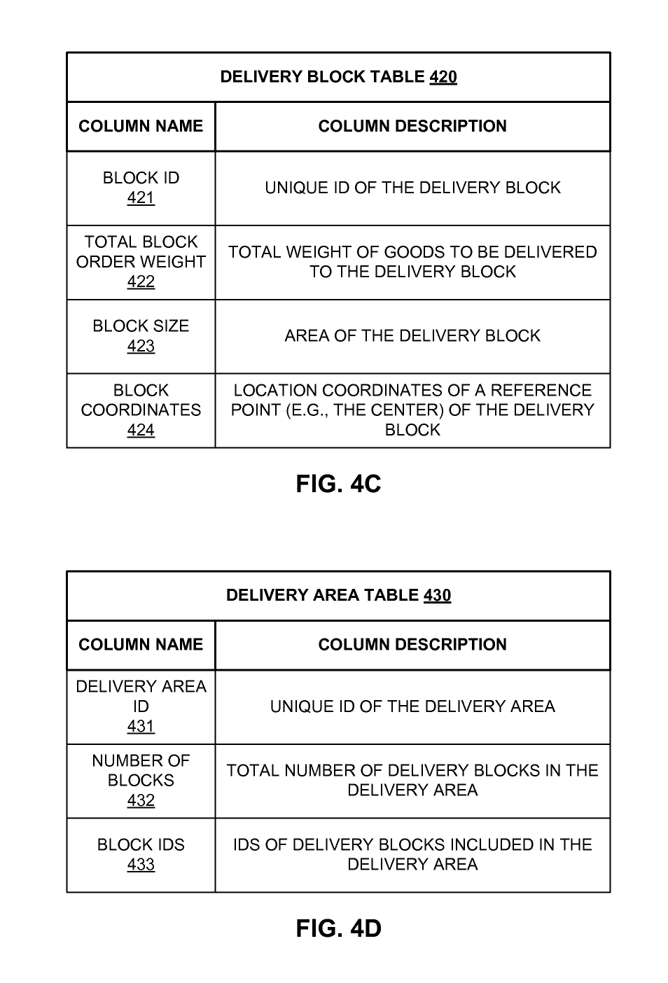

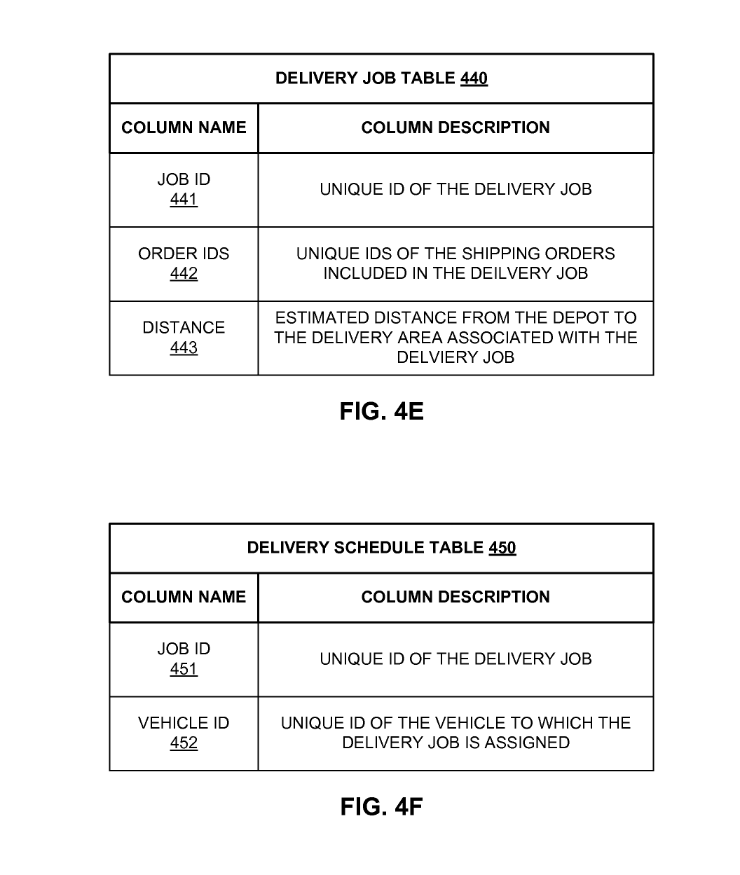

FIG. 3 is a block diagram of an example order/vehicle assignment application 300. In one example, the order/vehicle assignment application 300 may be one of the customer relationship management applications 250, the supply chain management applications 258, or another of the domain applications 134 of FIG. 2. As shown in FIG. 3, the order/vehicle assignment application 300 may include a region segmentation module 302, an order density determination module 304, a block merging module 306, a vehicle type cost module 308, a delivery area partitioning module 310, and a vehicle assignment module 312. Each of these modules may be implemented in hardware, or some combination of hardware and software. The order/vehicle assignment application 300 may also include other modules not explicitly depicted in FIG. 3, or may include fewer modules than depicted. Also, one or more of the modules 302-312 may be combined into fewer modules or separated into a greater number of modules. The order/vehicle assignment application 300 may also be coupled with a database 320 including one or more database tables 322 of information employed by the order/vehicle assignment application 300. In one example, the database 320 may exist as part of the database 130 of FIG. 1. A discussion of examples of the database tables 322 is presented below in conjunction with FIGS. 4A through 4F.

In one example, the scope of the order/vehicle assignment application 300 is a particular defined delivery region serviced by a single warehouse or depot from which cargo (e.g., goods, products, animals, people) are to be delivered by one or more delivery vehicles (e.g., bicycles, freight trucks, delivery vans, passenger vehicles, buses, ships, planes, etc.) to multiple destinations within the delivery region. The depot may or may not be located within the delivery region, depending on the implementation. The delivery region may include, but is not limited to, a city, a county, a metropolitan area, a state, and a country.

In the order/vehicle assignment application 300, the region segmentation module 302 may divide the delivery region into a number of smaller delivery blocks. In some examples, each of the delivery blocks is of approximately equal size within some particular or certain level of variation. For each of the delivery blocks generated by the region segmentation module 302, the order density determination module 304 may determine an order density. In one example, an order density of a delivery block may be the total size of all shipping orders in the delivery block, divided by the area of the delivery block. As employed herein, a shipping order is an order to deliver one or more items of cargo to a particular location or address. Depending on the particular implementation, the size of a shipping order may be the weight of the cargo associated with the shipping order, the volume of the cargo associated with the shipping order, the number of items or goods that constitute the cargo associated with the shipping order, or another metric. In the specific embodiments described in greater detail below, the size of a shipping order is the total weight of that shipping order.

After the order density determination module 304 determines the order density of each of the delivery blocks, the block merging module 306 may then merge adjacent delivery blocks that have corresponding order densities into separate, contiguous delivery areas. In addition, delivery blocks that are not merged with any other delivery blocks may constitute separate delivery areas. As is described in more detail below, the delivery areas provide the basis for organizing one or more shipping orders into delivery jobs for assignment to individual delivery vehicles for transport to their intended destinations.

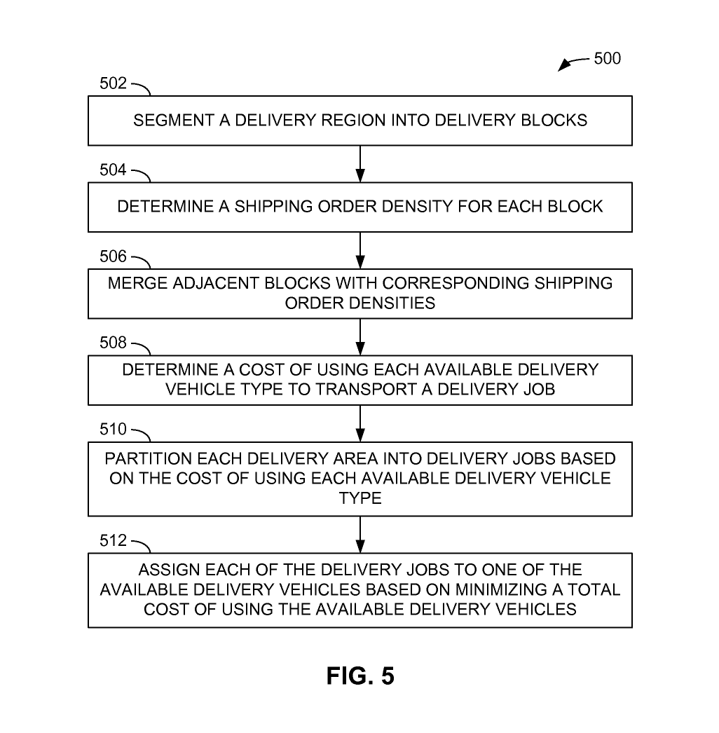

The vehicle type cost module 308 may determine a cost of using each vehicle type (e.g., bicycle, motorcycle, passenger vehicle, small truck, large moving van, etc.) of an available set of delivery vehicles relative to a range of possible order densities and a range of possible delivery distances. For example, presuming each type of available delivery vehicle possesses a particular cargo capacity and/or availability, a cost of using that vehicle type to deliver a full load of shipping orders to one or more individual shipping locations may be based on the distance from the depot to a delivery area, and may possibly include deliveries to one or more individual delivery blocks within the delivery area. Thus, this cost may be expressed in terms of the shipping order density associated with a delivery area, the distance between the depot and the delivery area, and possibly the distance between individual delivery blocks of the delivery area. In one example, the cost for each vehicle type may be expressed as a formula or equation taking as input at least one of the cargo capacity of the vehicle type, the distance from the depot to the delivery area, and the distance between adjacent delivery blocks. Further information regarding the generation of the cost of using a particular vehicle type is provided below in conjunction with FIG. 5.

Based on the cost of using each of the vehicle types, the delivery area partitioning module 310 may partition each of the delivery areas generated by the block merging module 306 into delivery jobs. As discussed herein, a delivery job may be one or more shipping orders that are to be transported to their destinations at the same time by a single available vehicle. In one example, the types of vehicles that exhibit the lowest cost for transporting the shipping orders to the delivery area are selected, and the capacity of the selected vehicle types may thus determine the size of the delivery job being generated. In some examples discussed more fully below with respect to FIG. 5, the delivery area partitioning module 310 may employ a selection algorithm, such as a greedy algorithm or a column generation algorithm, to partition each delivery area 404 into one or more delivery jobs.

Once the delivery jobs are generated, the vehicle assignment module 312 may then assign each of the delivery jobs to one of the delivery vehicles currently available at the depot. In at least some implementations, the assignment of delivery jobs to delivery vehicles is based on minimizing a total cost of using the delivery vehicles to transport the delivery jobs to their corresponding destinations. In an example discussed in greater detail below in conjunction with FIG. 5, the vehicle assignment module may utilize an integer linear programming algorithm for the assignment operation.

In employing at least some embodiments of the order/vehicle assignment application 300, the complexity of the task of assigning shipping orders to delivery vehicles of one or more types is reduced. More specifically, by generating contiguous delivery areas with delivery blocks having similar areas and order densities, the order/vehicle assignment application 300 may generate a reasonably optimal (e.g., approximately lowest cost) solution for delivering cargo to a multitude of destinations using fewer calculation iterations and, consequently, less processing bandwidth than other methods previously employed.

FIGS. 4A through 4F are descriptions of example database table formats employable for assigning shipping orders to delivery vehicles. More specifically, FIG. 4A describes the format for a vehicle table 400, FIG. 4B describes the format for a shipping order table 410, FIG. 4C describes the format for a delivery block table 420, FIG. 4D describes the format for a delivery area table 430, FIG. 4E describes the format for a delivery job table 440, and FIG. 4F describes the format for a delivery schedule table 450. In some examples, each of these tables 400, 410, 420, 430, 440, 450 may be one of the database tables 322 of the database 320 depicted in FIG. 3. However, FIGS. 4A through 4F represent just one possible arrangement and format of data employable by the order/vehicle assignment application 300 and the methods discussed below.

In FIG. 4A, the vehicle table 400 may include a separate row for each delivery vehicle available at a depot for the delivery of shipping orders to various destinations within a delivery region. For each vehicle, column values for a vehicle identifier (ID) 401, a vehicle type 402, a vehicle capacity 403, and a vehicle cost 404 may be provided in the vehicle table 400. The vehicle ID 401 may be an ID that is unique to the associated vehicle. The vehicle type 402 may indicate the particular type (e.g., small delivery truck, large delivery van, etc.) of the associated vehicle.

The vehicle capacity 403 may indicate the capacity of the associated vehicle. In one example, the vehicle capacity may be expressed as a constant maximum total weight or mass of cargo (e.g., in kilograms (kg) or pounds (lbs.)) that the vehicle may carry and transport at any one time. In another implementation, the vehicle capacity 403 may also take into account the speed and/or availability of the vehicle to determine the maximum cargo the vehicle can deliver over a certain distance in particular period of time. In this example, the vehicle capacity 403 may be expressed in units of kilogram-kilometers per hour (kg-km/hr), indicating the maximum cargo weight the vehicle may deliver one kilometer from the depot in an hour. Accordingly, for any particular time period (e.g., one day), the resulting capacity for the vehicle for that time period may be expressed in terms of the weight of cargo that can be transported one kilometer by multiplying the vehicle capacity 403 by that time period. In some implementations, the vehicle capacity 403 may also incorporate or otherwise consider the return distance from the delivery location to the depot to reflect an amount of time that the vehicle is not available to carry other shipping orders. Other methods for determining the value of the vehicle capacity 403 may be utilized in other examples.

The vehicle cost 404, in some embodiments, may be a formula or other mathematical expression that is a function of a distance the vehicle travels from the depot to a delivery destination. In various implementations, the cost for using a particular type of delivery vehicle may be based on at least travel distance, which may include fuel costs, maintenance costs, toll road fees, taxes, and the like. In at least some cases, the vehicle cost 404 may not be linearly related to the distance. In further implementations, the vehicle cost 404 may also include the cost of the driver of that vehicle type, which may be significant for those vehicles requiring special skill, experience, and/or licensing to operate. Other costs associated with operating each vehicle type may also be included.

FIG. 4B describes a shipping order table 410 in which each row describes a specific shipping order to be delivered to a particular destination address. For each shipping order, columns of the shipping order table 410 may provide a shipping order ID 411, an order weight 412, and an order address 413 for the associated shipping order. The shipping order ID 411 may be an ID that is unique for that shipping order. The order weight 412 may be the total weight of the cargo (e.g., goods or products) included in the associated shipping order. The order address 413 may be the delivery or destination address for the shipping order. In other examples, other forms of location information of the shipping order destination, such as latitude and longitude coordinates, may be stored in addition to, or in lieu of, the order address 413.

In FIG. 4C, the delivery block table 420 may include a separate row for each delivery block specified within the delivery region. For each delivery block, column values may be provided in the delivery block table 420 for a block ID 421, a total block order weight 422, a block size 423, and block coordinates 424. The block ID 421 may be an ID that is unique to the associated delivery block. The total block order weight 422 may be the total weight of goods for any and all shipping orders to be delivered to destinations located within the associated delivery block. Such information may be accumulated from the order weight 412 for each shipping order in the shipping order table 410 that is associated with an order address 413 located within the corresponding delivery block. The block size 423 may be the area (e.g., in square kilometers (km²) of the delivery block. Accordingly, in one example, the shipping order density for the delivery block may be calculated by dividing the total block order weight 422 by the block size 423. The block coordinates 424 may be location coordinates (e.g., latitude and longitude) for a reference point (e.g., the geographic center) of the associated delivery block.

FIG. 4D describes the delivery area table 430, which may include a row for each delivery area generated from the delivery blocks of the delivery region, as described above. Each delivery area may be associated with column values for a delivery area ID 431, a number of blocks 432, and one or more block IDs 433. The delivery area ID 431 may be an ID that is unique to the associated delivery area relative to other delivery areas. The number of blocks 432 may represent the total number of delivery blocks that constitute the associated delivery area. The block IDs 433 may provide a block ID 421 for each of the delivery blocks included in the delivery area. Other values, such as an average distance from the depot to one of the delivery blocks included in the delivery area, may also be included as another column value for the delivery area table 430 in other embodiments.

In FIG. 4E, the delivery job table 440 may include a row for each delivery job generated in the order/vehicle assignment application 300, as described above. Each delivery job may thus be associated with a column value for a job ID 441, one or more order IDs 442, and a distance 443. In one example, the job ID 441 may be an ID that is unique to the associated delivery job. The order IDs 442 may include the shipping order ID 411 from the shipping order table 410 for each shipping order included in the associated delivery job. The distance 443 may be the estimated distance from the depot to the delivery area corresponding to the delivery job, or to one of the delivery blocks specifically associated with the delivery job. In some examples, the distance 443 may be an average distance from the depot to the approximate center of the delivery area, or to the delivery blocks being serviced by the delivery job.

FIG. 4F describes the delivery schedule table 450, which may include a row for each assignment of a delivery job to a vehicle. In one implementation, each assignment is associated with column values for a job ID 451 and a vehicle ID 452. In one embodiment, the job ID 451 may be the same job ID 441 of the associated delivery job from the delivery job table 440, while the vehicle ID 452 may be the same vehicle ID 401 of the associated vehicle from the vehicle table 400.

In additional implementations, fewer, additional, and/or different column values may be employed for the rows of any of the database tables 400, 410, 420, 430, 440, and 450.

FIG. 5 is a flow diagram illustrating an example method 500 of assigning shipping orders to delivery vehicles. While the order/vehicle assignment application 300 (FIG. 3) and its constituent modules 302-312, as well as the database 320 discussed above, are presumed to be employed in the performance of the various operations of the method 500 in some examples, other applications, systems, and devices may perform these same operations in alternative implementations.

In the method 500, a delivery region of interest is segmented into multiple delivery blocks (operation 502). In an implementation, the delivery blocks may be defined by paths (e.g., streets, highways, etc.) navigable by at least one of the delivery vehicles. For example, a delivery block may be one or more city blocks of a particular city. In many embodiments, the delivery region may be segmented into delivery blocks only once, while in other implementations, the delivery region may be segmented into delivery blocks from time to time, based on, for example, changes in population, street construction, delivery patterns, and other aspects of the delivery region. Information describing each of the delivery blocks may be stored as rows in the delivery block table 420 of FIG. 4C, in one example.

A shipping order density for each of the delivery blocks may then be determined (operation 504). In one example, the shipping order density for a particular delivery block may be calculated by dividing the total weight of goods to be shipped to locations within the delivery block (e.g., the total block order weight 422 of the delivery block table 420 of FIG. 4C) by the area of the delivery block (e.g., the block size 423 of delivery block table 420).

Once the shipping order densities for the delivery blocks have been determined, adjacent delivery blocks with corresponding shipping order densities may be merged to form the delivery areas (operation 506), as noted above. The information describing each delivery area may be stored as rows in the delivery area table 430 of FIG. 4D.

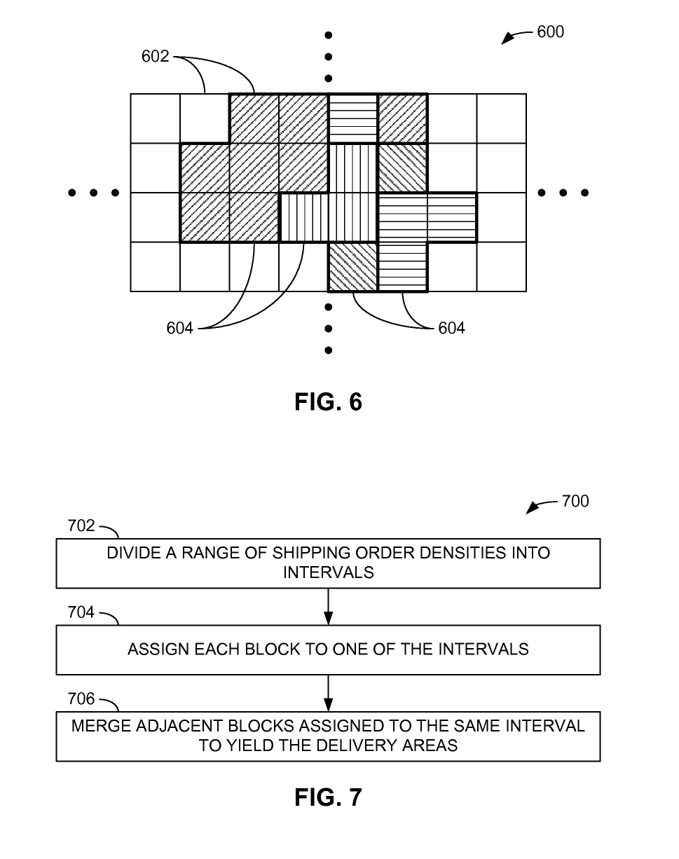

FIG. 6 is a graphical representation of an example delivery region 600 according to one embodiment, with example delivery blocks 602 and delivery areas 604 illustrated therein. While the delivery blocks 602 are depicted as square regions of identical size, other types of delivery blocks of different shapes (e.g. hexagonal blocks, or delivery blocks 602 of varying shape dictated by the particular geography or topology of the delivery region 600) may be utilized in other examples. The delivery blocks 602 may also be of varying size, based on any variance in shape of the delivery blocks 602. In another example, the boundaries of the delivery blocks 602 may be aligned with existing streets, highways, transportation barriers (e.g., lakes and rivers), and other features associated with the geography or topology of the delivery region 600.

In one implementation, each of the delivery blocks 602 may measure one or two kilometers (km) wide, but smaller or larger delivery blocks 602 may be employed in other embodiments. The size and/or shape of each of the delivery blocks 602, in some examples, may be chosen such that the cost of a delivery vehicle traveling from a location within one delivery block 602 to another location within an adjacent delivery block 602 is a small, definable quantity (or possibly negligible) for a particular type of delivery vehicle.

FIG. 6 further identifies each of the delivery blocks 602 having similar or corresponding shipping order densities by way of identical shading. Also in FIG. 6, the boundaries of the delivery areas 604 are designated by bold lines. In some implementations, only those delivery blocks 602 sharing a boundary side or segment may be merged, while in other examples, delivery blocks 602 sharing as little as a single boundary point may be merged. Individual delivery blocks 602 having at least one shipping order, but not merged with any other delivery block 602, may constitute separate delivery areas 604. In one example, those delivery blocks 602 not including at least one shipping order may not be assigned to any delivery area 604.

In reference to FIG. 6, FIG. 7 is a flow diagram illustrating an example method 700 of assigning delivery blocks 602 to delivery areas 604 based on shipping order densities. In one example, a number of order density intervals or “bins”, possibly ranging from zero to some expected or anticipated maximum shipping order size, may be defined (operation 702). Each delivery block 602 then may be assigned to a shipping order density interval corresponding to its total shipping order density (operation 704). Adjacent delivery blocks 602 whose shipping order densities reside in the same shipping order density interval may then be merged to form the delivery areas 604 (operation 706).

Returning to FIG. 5, a cost of using each available delivery vehicle type to transport a delivery job also may be determined (operation 508). In one implementation, the cost of each vehicle type (as described in the vehicle cost 404 column for a vehicle type of the vehicle table 400 (FIG. 4A)), as well as the cargo capacity of the vehicle type (as indicated in the vehicle capacity 403 for a vehicle type of the vehicle table 400) may be mapped or graphed relative to both a delivery distance (e.g., an average distance from the depot to a delivery area 604) and a shipping order density. In one example, the graph may be represented conceptually as a surface in a three-dimensional graph for each vehicle type, with each of the delivery distance and the shipping order density being represented as variables along one of an x-axis and a y-axis, and the resulting cost of the vehicle type being represented along a z-axis.

In a further implementation, the vehicle cost map or graph may be employed to generate one or more partitioning rules for partitioning a delivery area 604 into delivery jobs. Such rules may be stated in terms of which vehicle type provides the lowest cost based on the value of a shipping order density for a delivery area 604 and an average distance from the depot to the delivery area 604. An example of one such rule may be stated as “If the shipping order density for a delivery area is in the range [R0, R1) and the distance from the depot to the delivery area is in the range [D0, D1), select, based on availability, vehicle types in order of T1, T2, T3,” etc. As a result, if the shipping order density and distance are in the specified ranges for a particular rule, then a vehicle type may be selected from a ranked list, with vehicle type T1 being selected if available, vehicle type T2 being selected if available and vehicle type T1 is not available, and so on.

Based on the cost map and/or the partitioning rules, each of the delivery areas 604 may then be partitioned into one or more delivery jobs (operation 510). In some implementations, each delivery area 604 may be independently partitioned into delivery jobs, one at a time, according to some selection algorithm following the cost map and/or partitioning rules. In at least some examples, the size of each delivery job is restricted to the cargo capacity of a selected delivery vehicle that is available. The resulting delivery jobs may be stored in the delivery job table 440, described above in reference to FIG. 4E.

In one embodiment, the partitioning of the shipping orders of the delivery area 604 into individual delivery jobs is performed using a greedy algorithm, in which the most efficient vehicle type for a particular delivery area 604 that is still available is used to partition the next delivery job to match the capacity of that vehicle type. Each delivery job for a delivery area 604 would then be processed in that manner, one at a time, until all shipping orders are assigned to a delivery job.

In another embodiment, a column generation algorithm may be used to partition the delivery area 604 into delivery jobs. For example, using the cost map and/or the partitioning rules as a guide, the column generation algorithm may partition each delivery area 604 into delivery jobs multiple times and retain the results of each iteration. The column generation algorithm may then determine the overall cost of each iteration and select the lowest cost iteration and its associated delivery jobs.

Once the delivery jobs are generated, each of the delivery jobs may be assigned to a particular available vehicle based on minimizing a total cost of using the available vehicles (operation 512). In some implementations, the assignment of delivery jobs to available vehicles may be performed using integer linear programming (ILP). In one particular example, given a number of available vehicles V and a number of delivery jobs P, and employing a weight function C(i, j), in which C(i, j) is the cost of operating a vehicle i to deliver a delivery job j to its intended destination, a total cost function to be minimized that is based on the weight function can be expressed as an objective function for an integer linear program as

$$Min {\sum }_{i = 1}^{V} {\sum }_{j = 1}^{P} C ( i , j ) {x}_{ij}$$

In the objective equation, xᵢⱼ=1 if delivery job j is assigned to vehicle i, and xᵢⱼ=0 if delivery job j is not assigned to vehicle i.

Further, the objective function may be subject to the constraint

$${\sum }_{i = 1}^{V} {Capacity}_{i} * {x}_{ij} \geq {Requirement}_{j} , \\ j = 1 , 2 , … , P$$

In this constraint, Capacity, is the cargo capacity of vehicle i and Requirementⱼ is the total weight of the delivery job j. In other words, for each of the delivery jobs, the total weight of the delivery job is less than the capacity of the vehicle to which the delivery job is assigned.

In one example, the cost function C(i, j) employed in the object function may be defined as

C(i,j)=Cᵢ(D)+k|j|

In the particular cost function C(i, j) shown above, Cᵢ(D) is the cost of transporting goods in the vehicle i over a distance D from the depot to a delivery area 604, k is a coefficient associated with a presumed constant cost of transporting goods in the vehicle i from one delivery block 602 of the delivery area 604 to an adjacent delivery block, and |j| is the number of delivery blocks 602 in the delivery area 604 associated with the delivery job j. In some examples, the cost function C(i, j) is stored as the vehicle cost 404 for the vehicle i in the vehicle table 400. Also, in other implementations, other functions may be employed as the cost function C(i, j).

While the operations 502 through 512 of the method 500 of FIG. 5 are shown in a specific order, other orders of operation, including possibly concurrent or repeated execution of at least portions of one or more operations, may be possible in some implementations of method 500, as well as other methods discussed herein. For example, the determination of the cost of using each available delivery vehicle type (operation 508) may be performed before or concurrently with the delivery region segmentation, shipping order density determination, and block merging operations (e.g., operations 502, 504, and 506).

Also, in at least some implementations, some portions of the method 500 may be executed repeatedly or periodically (e.g., every hour, every few hours, or every day) for any shipping orders which are to be satisfied immediately or within some future time window. As a result, any consideration of timing conditions is omitted, thus potentially reducing further the complexity of the assignment of shipping orders to delivery vehicles. Other operations, such as the segmentation of the delivery region into delivery blocks 602 (operation 502) and the determination of the cost of using each vehicle type to transport a delivery job (operation 508) may be performed once, or sparingly.

As a result of at least some of the embodiments described above, the complexity of the task of assigning shipping orders to available delivery vehicles of varying cargo capacities is reduced while providing a near-optimally efficient, low-cost solution. Such a reduction in complexity may, in turn, reduce the amount of time needed to perform the assignment, and also may allow the assignment to be executed repeatedly to allow adaptation to changing conditions regarding the orders to be shipped, the vehicles that are currently available, and so on. Further, such reductions in complexity may become even more important with increases in the size of the delivery region 600, the number of shipping orders to be executed, the number of vehicles available, and the like.

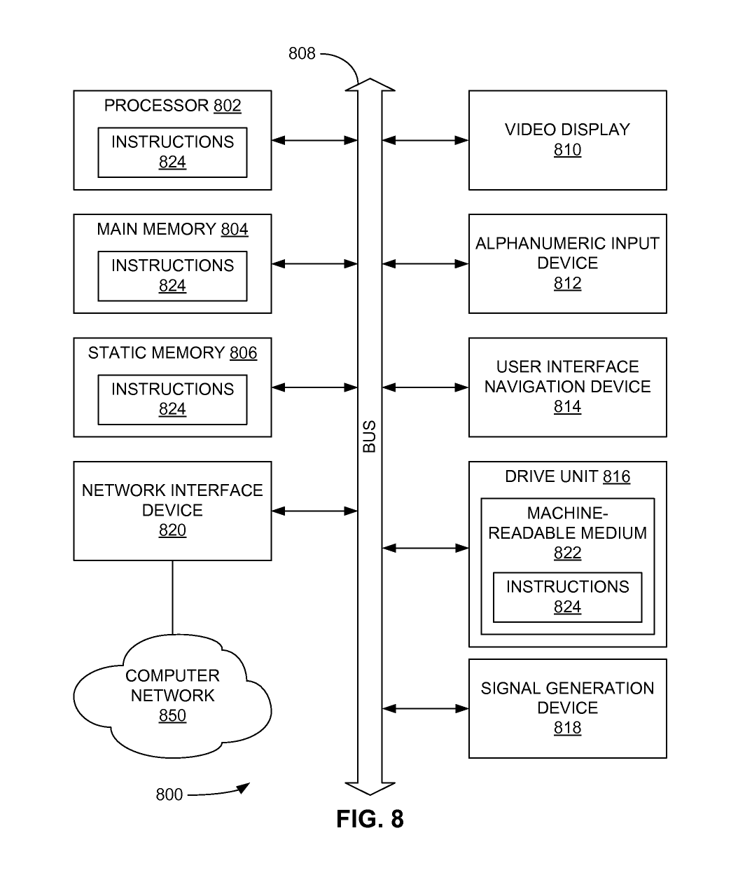

FIG. 8 depicts a block diagram of a machine in the example form of a processing system 800 within which may be executed a set of instructions 824 for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine is capable of executing a set of instructions 824 (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 800 includes a processor 802 (e.g., a central processing unit (CPU), a graphics processing unit (GPU), or both), a main memory 804 (e.g., random access memory), and static memory 806 (e.g., static random-access memory), which communicate with each other via bus 808. The processing system 800 may further include video display unit 810 (e.g., a plasma display, a liquid crystal display (LCD), or a cathode ray tube (CRT)). The processing system 800 also includes an alphanumeric input device 812 (e.g., a keyboard), a user interface (UI) navigation device 814 (e.g., a mouse), a disk drive unit 816, a signal generation device 818 (e.g., a speaker), and a network interface device 820.

The disk drive unit 816 (a type of non-volatile memory storage) includes a machine-readable medium 822 on which is stored one or more sets of data structures and instructions 824 (e.g., software) embodying or utilized by any one or more of the methodologies or functions described herein. The data structures and instructions 824 may also reside, completely or at least partially, within the main memory 804, the static memory 806, and/or within the processor 802 during execution thereof by processing system 800, with the main memory 804, the static memory 806, and the processor 802 also constituting machine-readable, tangible media.

The data structures and instructions 824 may further be transmitted or received over a computer network 850 via network interface device 820 utilizing any one of a number of well-known transfer protocols (e.g., HyperText Transfer Protocol (HTTP)).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the processing system 800) or one or more hardware modules of a computer system (e.g., a processor 802 or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 802 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules include a general-purpose processor 802 that is configured using software, the general-purpose processor 802 may be configured as respective different hardware modules at different times. Software may accordingly configure the processor 802, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses that connect the modules). In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 802 or processor-implemented modules. The performance of certain of the operations may be distributed among the one or more processors 802, not only residing within a single machine but deployed across a number of machines. In some example embodiments, the processors 802 may be located in a single location (e.g., within a home environment, within an office environment, or as a server farm), while in other embodiments, the processors 802 may be distributed across a number of locations.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method of assigning shipping orders to delivery vehicles, the method comprising:
segmenting a delivery region into a plurality of delivery blocks;
determining a shipping order density for each of the plurality of delivery blocks;
merging adjacent ones of the plurality of delivery blocks having corresponding shipping order densities to yield a plurality of delivery areas;
determining a cost of using each of a plurality of vehicle types of available delivery vehicles to transport a delivery job relative to a cargo capacity of the vehicle type, a delivery distance, and a shipping order density;
partitioning each of the plurality of delivery areas into delivery jobs based on the cost of using each of the plurality of vehicle types; and
assigning, using at least one processor of a machine, each of the delivery jobs to one of the available delivery vehicles based on minimizing a total cost of using the available delivery vehicles to transport the delivery jobs.

2. The method of claim 1, wherein the plurality of delivery blocks are of equal area within a certain level of variation.

3. The method of claim 1, wherein the plurality of delivery blocks are defined by paths navigable by at least one of the available delivery vehicles.

4. The method of claim 1, wherein the shipping order density for each of the plurality of delivery blocks comprises a weight of cargo to be delivered per unit area to the corresponding delivery block.

5. The method of claim 1, wherein the merging of adjacent ones of the plurality of delivery blocks comprises:
dividing a range of the shipping order densities into a plurality of intervals;
assigning each of the plurality of delivery blocks into a corresponding one of the plurality of intervals; and
merging adjacent ones of the plurality of delivery blocks assigned to a same interval to yield the plurality of delivery areas.

6. The method of claim 1, wherein the cost of using a particular vehicle type to transport a delivery job includes a cost of transporting the particular vehicle type the delivery distance, and a cost of transporting the particular vehicle type between adjacent delivery blocks multiplied by a number of delivery blocks corresponding to the delivery job.

7. The method of claim 1, further comprising generating rules for the partitioning of each of the plurality of delivery areas based on the cost of using each of the vehicle types of available delivery vehicles to transport a delivery job, wherein the partitioning of each of the plurality of delivery areas is based on the generated rules.

8. The method of claim 1, wherein at least one of the plurality of delivery jobs comprises a plurality of the shipping orders.

9. The method of claim 1, wherein the partitioning of each of the plurality of delivery areas into delivery jobs employs a greedy selection algorithm.

10. The method of claim 1, wherein the partitioning of each of the plurality of delivery areas into delivery jobs employs a column generation algorithm.

11. The method of claim 1, wherein a size of at least some of the delivery jobs is aligned to the cargo capacity of one of the vehicle types of the available delivery vehicles.

12. The method of claim 1, wherein the assigning of each of the delivery jobs to one of the available delivery vehicles employs integer linear programming.

13. A computer-readable storage medium comprising instructions that, when executed by at least one processor of a computing system, cause the computing system to perform operations comprising:
segmenting a delivery region into a plurality of delivery blocks;
determining a shipping order density for each of the plurality of delivery blocks, the shipping order density for one of the plurality of delivery blocks comprising a weight of cargo to be delivered per unit area to the one of the plurality of delivery blocks;
merging adjacent ones of the plurality of delivery blocks having corresponding shipping order densities to yield a plurality of delivery areas;
determining a cost of using each of a plurality of vehicle types of available delivery vehicles to transport a delivery job relative to a cargo capacity of the vehicle type, a delivery distance, and a shipping order density;
partitioning each of the plurality of delivery areas into delivery jobs based on the cost of using each of the plurality of vehicle types, wherein at least one of the delivery jobs comprises a plurality of shipping orders; and
assigning each of the delivery jobs to one of the available delivery vehicles based on minimizing a total cost of using the available delivery vehicles to transport the delivery jobs.

14. A computing system comprising:
at least one processor; and
memory comprising instructions that, when executed by the at least one processor, cause the at least one processor to perform operations comprising:
segmenting a delivery region into a plurality of delivery blocks;
determining a shipping order density for each of the plurality of delivery blocks;
merging adjacent ones of the plurality of delivery blocks having corresponding shipping order densities to yield a plurality of delivery areas;
determining a cost of using each of a plurality of vehicle types of available delivery vehicles to transport a delivery job relative to a cargo capacity of the vehicle type, a delivery distance, and a shipping order density;
partitioning each of the plurality of delivery areas into delivery jobs based on the cost of using each of the plurality of vehicle types; and
assigning each of the delivery jobs to one of the available delivery vehicles based on minimizing a total cost of using the available delivery vehicles to transport the delivery jobs.

15. The computing system of claim 14, wherein the merging of adjacent ones of the plurality of delivery blocks comprises:
dividing a range of the shipping order densities into a plurality of intervals;
assigning each of the plurality of delivery blocks into a corresponding one of the plurality of intervals; and
merging adjacent ones of the plurality of delivery blocks assigned to a same interval to yield the plurality of delivery areas.

16. The computing system of claim 14, wherein the cost of using a particular vehicle type to transport a delivery job includes a cost of transporting the particular vehicle type the delivery distance, and a cost of transporting the particular vehicle type between adjacent delivery blocks multiplied by a number of delivery blocks corresponding to the delivery job.

17. The computing system of claim 14, wherein the operations further comprise generating rules for the partitioning of each of the delivery areas based on the cost of using each of the vehicle types of available delivery vehicles to transport a delivery job, wherein the partitioning of each of the plurality of delivery areas is based on the generated rules.

18. The computing system of claim 14, wherein the partitioning of each of the plurality of delivery areas into delivery jobs employs a greedy selection algorithm.

19. The computing system of claim 14, wherein the partitioning of each of the plurality of delivery areas into delivery jobs employs a column generation algorithm.

20. The computing system of claim 14, wherein the assigning of each of the delivery jobs to one of the available delivery vehicles employs integer linear programming.
